(19) United States
(12) Patent Application Publication
(10) Pub. No.: US 2020/0394528 A1
(43) Pub. Date: Dec. 17, 2020

(54) PREDICTION MODEL

(71) Applicant: International Business Machines Corporation, Armonk, NY (US)

(72) Inventors: Yasue Makino, Tokyo (JP); Hiromi Kobayashi, Tokyo (JP); Yusuke Matsumoto, Tokyo (JP); Hirokazu Kobayashi, Tokyo (JP)

(21) Appl. No.: 16/508,379

(22) Filed: Jul. 11, 2019

Related U.S. Application Data
(63) Continuation of application No. 16/438,927, filed on Jun. 12, 2019.

(51) Int. Cl. G06N 5/00; G06F 17/18; G06K 9/62

(52) U.S. Cl. CPC G06N 5/003; G06K 9/6285; G06K 9/6219; G06F 17/18

(57) ABSTRACT

A prediction model can be created by reading an objective variable and a plurality of explanatory variables into a memory, and subsequently calculating a degree of influence of each of the plurality of explanatory variables on the objective variable. The determination of whether the two highest degrees of influence are approximate with each other or not can be performed. In the case that the two highest degrees of influence are approximate with each other, then a stepwise method can be carried out in order to select one explanatory variable among the plurality of explanatory variables. A prediction model can be subsequently created using the selected explanatory variable.

### BACKGROUND

Various methods are available for creating prediction models, particularly prediction models used for data analysis. There is generally no definitive criterion used for selecting a method among such methods. However, the following criteria can be desirable for selecting a method among such methods: ease of interpretation of a prediction model for analysis, the ability to identify factors which influence an objective variable, high accuracy of prediction, or a combination of the above criteria.

A decision tree can be used in a wide variety of software applications and can be known as a prediction model. In a decision tree, pairs of an objective variable and each of a plurality of explanatory variables which can influence an objective variable are examined one by one to select an explanatory variable among a plurality of explanatory variables, in order to create a prediction model. Thus, it can be understood that a decision tree can capture only a partial relationship in the whole of a prediction model, but interpretation of a prediction model can be relatively easy. Further, a factor which influences an objective variable is relatively often identified in a decision tree.

### SUMMARY

Embodiments of the present disclosure can be directed to a method, a computer system, and a computer program product for creating a prediction model.

Embodiments can be directed towards a computer-implemented method for creating a prediction model. The method includes reading an objective variable and a plurality of explanatory variables into a memory, calculating a degree of influence of each of the plurality of explanatory variables on the objective variable, determining whether the two highest degrees of influence are approximate with each other or not, if the two highest degrees of influence are approximate with each other, carrying out a stepwise method to select one explanatory variable among the plurality of explanatory variables, and creating a prediction model using the selected explanatory variable.

Embodiments can also be directed towards a computer system. The computer system may include one or more computer processors, and a memory storing a program which performs, on the processor, an operation for performing the method disclosed herein.

Embodiments can also be directed towards a computer program product. The computer program product may include a computer-readable storage medium having program instructions embodied therewith. The program instructions are executable by a computer to cause a computer system to perform the method disclosed herein.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

The disclosure will provide details in the following description of embodiments with reference to the following figures. The figures are not necessarily drawn to scale. The figures are merely schematic representations, not intended to portray specific parameters of the present disclosure. The figures are intended to depict only typical embodiments of the present disclosure. In the figures, like numbering represents like elements.

FIG. 1 depicts an example architecture of a computer system which can be used in accordance with embodiments of the present disclosure.

FIG. 2A is a flow diagram depicting a process for creating a prediction model, in accordance with embodiments consistent with the figures.

FIG. 2B depicts a flow diagram depicting a process for using the prediction model made in accordance with embodiments consistent with the figures.

FIG. 3 is an overall functional block diagram depicting computer system hardware in relationship to the process of FIG. 2A, in accordance with embodiments consistent with the figures.

FIG. 4A depicts relationships between an objective variable and a plurality of explanatory variables, which are used for selecting, according to a decision tree algorithm, one explanatory variable which influences an objective variable, according to embodiments consistent with the figures.

FIG. 4B depicts relationships between an objective variable and a plurality of explanatory variables, such as a stepwise logistic regression or a stepwise linear regression, which are used for selecting, in a stepwise method, one explanatory variable which influences an objective variable, according to embodiments consistent with the figures.

While embodiments are amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the disclosure.

In the drawings and the Detailed Description, like numbers generally refer to like components, parts, steps, and processes.

### DETAILED DESCRIPTION

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to sensuously understand the embodiments disclosed herein.

As can be appreciated by those of skill in the art, embodiments of the present disclosure can be embodied as a method, a computer system, or a computer program product. Accordingly, embodiments of can take the form of an entirely hardware-based embodiment, an entirely software-based embodiment, including, for example, firmware, resident software ad microcode, and the like, or can take the form of embodiments combining software-based and hardware-based aspects, which can be collectively referred to herein as a “circuit,” a “module,” or a “system.”

As used herein, the expression “a/one” should be understood as “at least one.” The expression “comprise(s)/comprising a/one” should be understood as “comprise(s)/comprising at least one.” The expression “comprise(s)/comprising” should be understood as “comprise(s)/comprising at least.” The expression “/” should be understood as “and/or.”

To define more clearly terms used herein, example definitions of the terms are provided hereinafter. These terms should be interpreted broadly as known to a person skilled in the art or a technical field to which the present disclosure pertains.

As used herein, the term “a prediction model” can refer to mathematical formulas or rules which can be used for predicting, on the basis of patterns that exists in past data, events that are likely to occur in future. In embodiments, a prediction model can be any model which can have a decision tree structure. Thus, a prediction model can be implemented as any decision tree. A prediction model can be used for, for example, but not limited to, data analysis. In this case, a prediction model can be a prediction model for data analysis.

As used herein, the term “an objective variable” can refer to any information to be predicted, such as a result in a causal relationship or an output of a function. In some embodiments, an objective variable can refer to a variable to express a decision in outcome. An objective variable can be of, for example, but not limited to a continuous value or a binary value.

As used herein, the term “an explanatory variable” can refer to any information which is used for prediction, such as a cause in a causal relationship or an input of a function. In some embodiments, an explanatory variable can refer to a variable which is supposed to explain the other. An explanatory variable can be a type of “an independent variable.” These two terms, “an explanatory variable” and “an independent variable,” can be often used interchangeably. An explanatory variable can be of, for example, but not limited to a continuous value or a value including a category type.

As used herein, the term “a decision tree” can refer to a data analysis method for deriving rules, while dividing or sub-grouping data according to an influential cause, i.e., an explanatory variable, i.e., an objective variable, for a result. In some embodiments, a decision tree can be a technique for finding and describing structural pattern in data as tree structures. The decision tree can be used for achieving a more concise and perspicuous representation of the relationship between an objective variable and a plurality of explanatory variables. The decision tree can be based on a multistage or hierarchical decision scheme or tree structure. The decision tree can be composed of a root node, a set of internal nodes and a set of terminal nodes.

Embodiments of the present disclosure is based on the following perceptions. As stated hereinabove, a factor which influences an objective variable is relatively often identified in a decision tree. However, this identification cannot be always attained. When interpretation of a prediction model is difficult, it seems that many analysts consider another or other analysis methods which provide easiness of interpretation as well as an increased accuracy of prediction. Accordingly, there is need to provide a method which provides easiness of interpretation as well as an increased accuracy of prediction.

When there is a plurality of explanatory variables which influence an objective variable, there is a case that their differences in the influence on an objective variable are small relative to one another. In this case, it is difficult to select one explanatory variable. Accordingly, there is need to select one explanatory variable, in such a case.

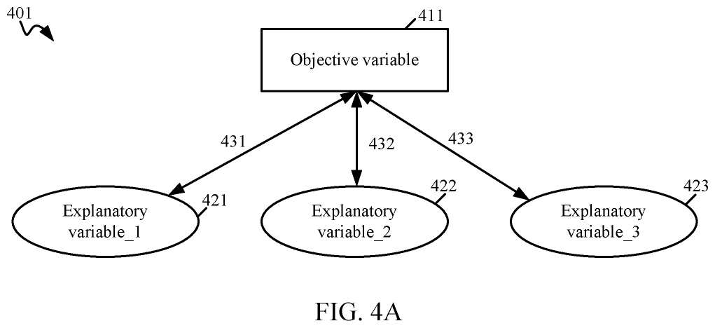

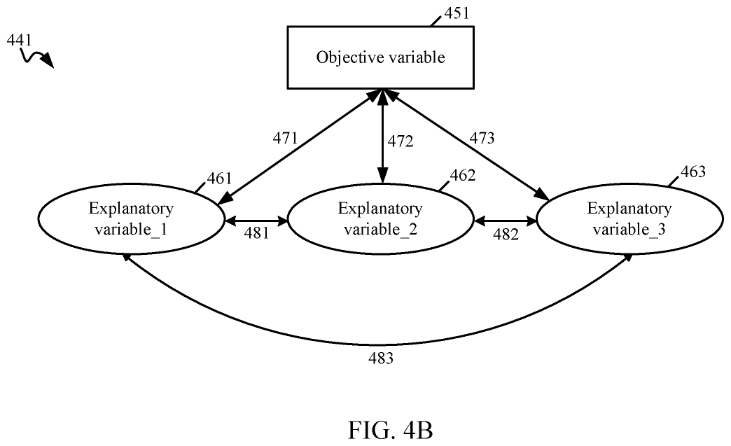

A selection of an explanatory variable which influences an objective variable can be made by the following two methods: a decision tree algorithm, and a stepwise method. As depicted in FIG. 4A, the decision tree algorithm uses a relationship between an objective variable and a plurality of explanatory variables, where the relationship is used for selecting, according to a decision tree algorithm, one explanatory variable which influences an objective variable. As depicted in FIG. 4B, the stepwise method uses a relationship between an objective variable and a plurality of explanatory variables, where the relationship is used for selecting, in a stepwise method, one explanatory variable which influences an objective variable.

FIG. 4A illustrates a relationship 401 between an objective variable 411 and a plurality of explanatory variables 421, 422 and 423. Execution of the decision tree algorithm for selecting an explanatory variable includes selecting, according to a decision tree algorithm, one explanatory variable which influences an objective variable 411. Even when influences of a plurality of explanatory variables 421, 422 and 423 are equivalent to one another, execution of the decision tree algorithm includes assessing each pair of the objective variable 411 and an explanatory variable as to their relationship one by one, i.e., a pair 431 of the objective variable 411 and the explanatory variable_1 421, a pair 432 of the objective variable 411 and the explanatory variable_2 422, and a pair 433 of the objective variable 411 and the explanatory variable_3 423 and then selecting one explanatory variable among a plurality of explanatory variables 421, 422 and 423.

FIG. 4B illustrates a relationship 441 between an objective variable 451 and a plurality of explanatory variables 461, 462 and 463.

Execution of the stepwise method for selecting an explanatory variable includes selecting one explanatory variable which influences an objective variable 451. When influences of a plurality of explanatory variables 461, 462 and 463 are equivalent to one another, execution of the stepwise method includes assessing each pair of the objective variable 451 and an explanatory variable as to their relationship one by one, i.e., a pair 471 of the objective variable 451 and the explanatory variable_1 461, a pair 472 of the objective variable 451 and the explanatory variable_2 462 and a pair 473 of the objective variable 451 and the explanatory variable_3 463, as well as each pair of two explanatory variables, i.e., a pair 481 of two explanatory variables 461 and 462, a pair 482 of two explanatory variables 462 and 463 and a pair 483 of two explanatory variables 463 and 461, and then selecting one explanatory variable among a plurality of explanatory variables 461, 462 and 463.

As stated hereinabove, in the execution of selecting one explanatory variable using the decision tree algorithm, relationships between two explanatory variables, i.e., a relationship between two explanatory variables 421 and 422, a relationship between two explanatory variables 422 and 423, and a relationship between two explanatory variables 423 and 421 are not taken into account. Meanwhile, as stated hereinabove, in the execution of selecting one explanatory variable using the stepwise method, relationships (multicollinearity) between two explanatory variables, i.e., a relationship 481 between two explanatory variables 461 and 462, a relationship 482 between two explanatory variables 462 and 463, and a relationship 483 between two explanatory variables 463 and 461 are taken into account

Explanatory variables whose differences in influence are small mean that they have equivalent abilities to explain an objective variable. If explanatory variables have high correlation, even selecting one of the highly correlated explanatory variables causes no significant difference. However, when there is no correlationship between explanatory variables but when the accuracies up to the node are equivalent, a question as to which explanatory variable is to be selected needs to be answered. Accordingly, there is a need for more precisely selecting an explanatory variable, even when there is no correlationship between explanatory variables but when the accuracies up to the node are equivalent.

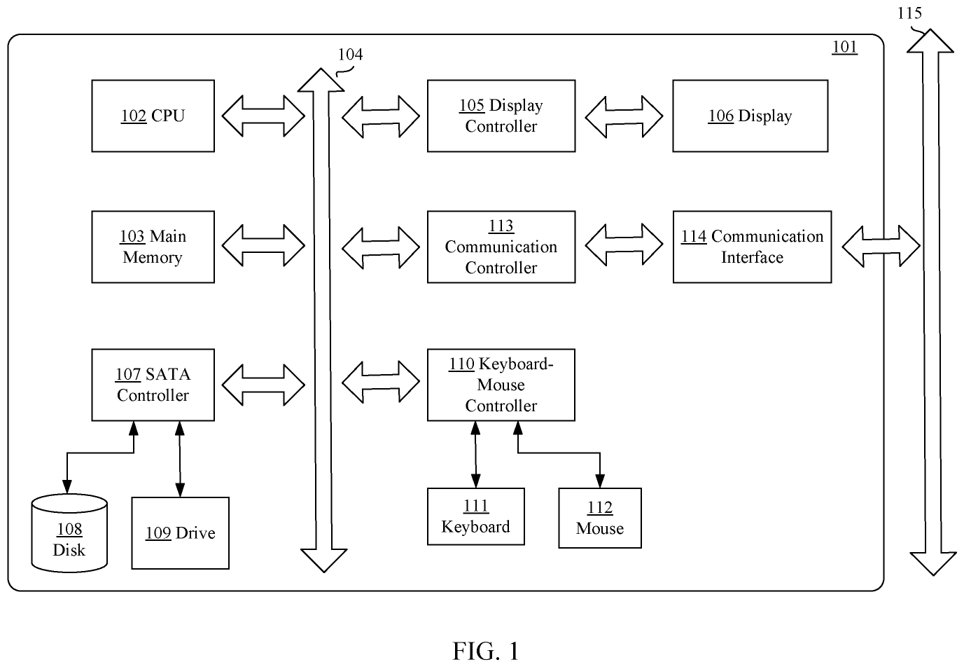

Hereinafter, the various embodiments of the present disclosure will be described with reference to the accompanying FIGS. 1, 2A, 2B and 3.

FIG. 1 is an example system architecture of a computer system which can be used in accordance with embodiments of the present disclosure.

A computer system 101 can be, for example, but is not limited to, a desktop, a laptop, a notebook or a server computer. The server computer can include, but is not limited to, a workstation, a rack-mount type server, a blade type server, a mainframe server, or a cloud server and can run, for example, a hypervisor for creating and running one or more virtual machines. The computer system 101 can include one or more CPUs 102 and a main memory 103 connected to a bus 104. The CPU 102 can be based on a 32-bit or 64-bit architecture. The CPU 102 can be, for example, but is not limited to, the Power® series of International Business Machines Corporation; the Core i™ series, the Core 2™ series, the Atom™ series, the Xeon™ series, the Pentium® series, or the Celeron® series of Intel Corporation; or the Phenom™ series, the Athlon™ series, the Turion™ series, or Sempron™ of Advanced Micro Devices, Inc. (“Power” is registered trademark of International Business Machines Corporation in the United States, other countries, or both; “Core i,” “Core 2,” “Atom,” and “Xeon” are trademarks, and “Pentium” and “Celeron” are registered trademarks of Intel Corporation in the United States, other countries, or both; “Phenom,” “Athlon,” “Turion,” and “Sempron” are trademarks of Advanced Micro Devices, Inc. in the United States, other countries, or both).

A display 106 such as a liquid crystal display (LCD) can be connected to the bus 104 via a display controller 105. The display 106 can be used to display, for management of the computer(s), information on a computer connected to a network via a communication line and information on software running on the computer using an appropriate graphics interface. The display can have a touch screen or a non-touch screen. The display can be for example, but not limited to, a LCD, PDP, OEL or a projection type display. A disk 108 such as a hard disk or a solid state drive, SSD, and a drive 109 such as a CD, a DVD, or a BD (Blu-ray disk) drive can be connected to the bus 104 via an SATA or IDE controller 107. Moreover, a keyboard 111 and a mouse 112 can be connected to the bus 104 via a keyboard-mouse controller 110 or USB bus (not shown).

An operating system, programs providing Windows®, UNIX® Mac OS®, Linux®, or a Java® processing environment, Java® applications, a Java® virtual machine (VM), and a Java® just-in-time (JIT) compiler, such as J2EE®, other programs, and any data can be stored in the disk 108 to be loadable to the main memory. (“Windows” is a registered trademark of Microsoft corporation in the United States, other countries, or both; “UNIX” is a registered trademark of the Open Group in the United States, other countries, or both; “Mac OS” is a registered trademark of Apple Inc. in the United States, other countries, or both; “Linux” is a registered trademark of Linus Torvalds in the United States, other countries, or both; and “Java” and “J2EE” are registered trademarks of Oracle America, Inc. in the United States, other countries, or both).

The drive 109 can be used to install a program, such as the computer program of embodiments of the present disclosure, readable from a CD-ROM, a DVD-ROM, or a BD to the disk 108 or to load any data readable from a CD-ROM, a DVD-ROM, or a BD into the main memory 103 or the disk 108, if necessary.

A communication interface 114 can be based on, for example, but is not limited to, the Ethernet® protocol. The communication interface 114 can be connected to the bus 104 via a communication controller 113, physically connects the computer system 101 to a communication line 115, and can provide a network interface layer to the TCP/IP communication protocol of a communication function of the operating system of the computer system 101. In this case, the communication line 115 can be a wired LAN environment or a wireless LAN environment based on wireless LAN connectivity standards, for example, but is not limited to, IEEE® 802.11a/b/g/n (“IEEE” is a registered trademark of Institute of Electrical and Electronics Engineers, Inc. in the United States, other countries, or both).

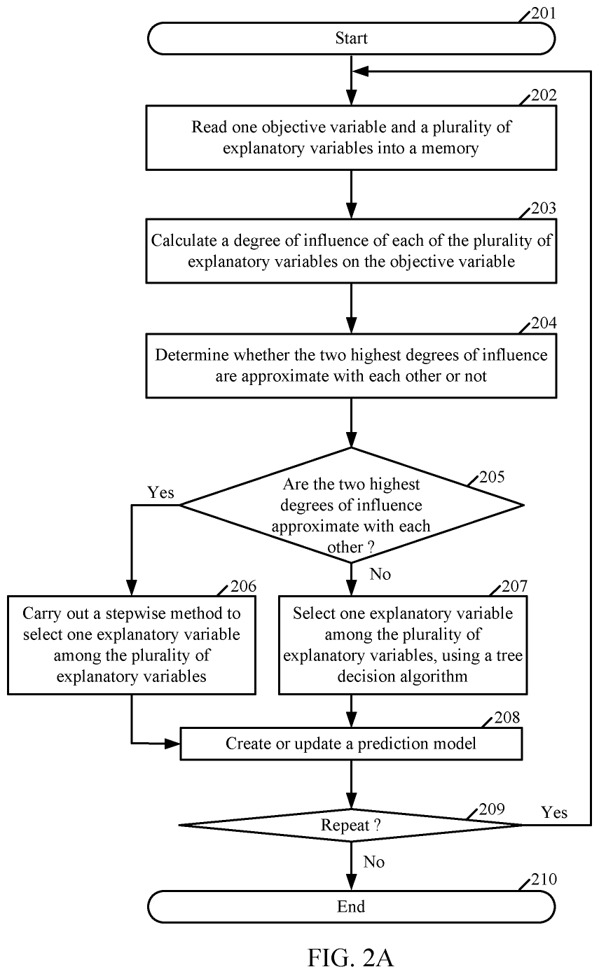

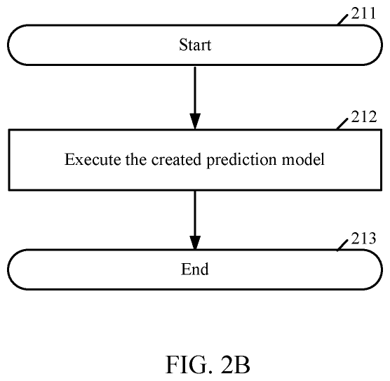

FIG. 2A illustrates a flow diagram depicting a process for creating a prediction model in accordance with embodiments of the present disclosure. A computer system mentioned below can be the same or different from the computer system 101 described in FIG. 1.

At operation 201, the computer system starts the aforesaid process.

At operation 202, the computer system reads an objective variable and a plurality of explanatory variables into a memory. These variables can be read from a storage in which a set of data is stored. The storage can be an internal storage of the computer system or can be accessed by the computer system through a network, such as an internetwork or an internet.

At operation 203, the computer system calculates a degree of influence of each of the plurality of explanatory variables on the objective variable. The calculation can be made, for example, using a decision tree algorithm, such as a C&RT algorithm or a CHAID algorithm. C&RT can be understood to refer to “Classification and Regression Trees.” CHAID can be understood to refer to “Chi-squared Automatic Interaction Detector,” an algorithm that is a highly efficient statistical technique for segmentation, or tree growing. The following reference describes the C&RT algorithm and the CHAID algorithm in detail: “IBM SPSS Modeler 18.1.1 Algorithms Guide,” IBM ®, 2017.

A. C&RT Algorithm

C&RT functions by selecting branch nodes such that children nodes created by branching have a higher purity than a parent node. Here, the purity represents similarity of the values of a field. In a completely pure node, fields of all records have the same value. C&RT defines an impurity to measure impurities of node branches. Method of calculating the impurity can be chosen according to the scale of the fields. There can be different impurity measures used to find splits for C&RT models, depending on the type of the target field. For example, Gini, towing or the least-squared deviation (LSD) can be used.

The following is a method of calculating the Gini impurity when fields are composed of two categories.

The Gini index g(t) at a node tin a C&RT tree, can be understood to be:

$$g ( t ) = {\sum }_{i \neq j} p ( j \vert t ) p ( i \vert t )$$

where i and j are categories of the target field, and p(j|t), p(j, t), and p(t) can be understood to be:

$$p ( j \vert t ) = \frac{p ( j \vert t )}{p ( t )} \\ p ( j , t ) = \frac{π ( j ) {N}_{j} ( t )}{{N}_{j}} \\ p ( t ) = {\sum }_{j} p ( j , t )$$

where π(j) is the prior probability value for category j, Nj(t) is the number of records in category j of node t, and Nj is the number of records of category j in the root node. Note that when the Gini index is used to find the improvement for a split during tree growth, only those records in node t and the root node with valid values for the split-predictor are used to compute Nj(t) and Nj, respectively.

The equation for the Gini index can also be written as follows:

$$g ( t ) = 1 - {\sum }_{j} {p}^{2} ( j \vert t )$$

Thus, when the records in a node are evenly distributed across the categories, the Gini index takes its maximum value of 1-(1/k), where k is the number of categories for the target field. When all records in the node belong to the same category, the Gini index equals zero.

The Gini criterion function Φ(s, t) for split s at node t is defined as follows:

Φ(s, t)=g(t)-p_{L} g(t_{L})-p_{R} g(t_{R})

where p_{L} is the proportion of records in t sent to the left child node, and p_{R} to the right child node. The proportions p_{L} and p_{R} can be defined as follows:

$${p}_{L} = \frac{p ( {t}_{L} )}{p ( t )}$$

$$and$$

$${p}_{R} = \frac{p ( {t}_{R} )}{p ( t )}$$

The split is chosen to maximize the value of Φ(s, t).

For each of the plurality of explanatory variables on the objective variable, Φ(s, t) is calculated as a degree of influence on an explanatory variable on the object variable and then a degree is selected so as to maximize Φ(s, t). The degrees can be sorted in descending order.

Using the significance of a statistical test as a criterion, the CHAID algorithm evaluates all of the values of a potential predictor field. It merges values that are judged to be statistically homogeneous, i.e., similar, with respect to the target variable and maintains all other values that are heterogeneous, i.e., dissimilar. It then selects the best predictor to form the first branch in the decision tree, such that each child node is made of a group of homogeneous values of the selected field. This process continues recursively until the tree is fully grown. The statistical test used depends upon the measurement level of the target field. If the target field is continuous, an F test is used. If the target field is categorical, a chi-squared test is used. CHAID is not a binary tree method, that is, it can produce more than two categories at any particular level in the tree. Therefore, it tends to create a wider tree than do the binary growing methods. It works for all types of variables, and it accepts both case weights and frequency variables. It handles missing values by treating them all as a single valid category.

At operation 204, the computer system determines whether the two highest degrees of influence are approximate with each other or not. If the judgment is positive, the computer system proceeds to operation 206. Meanwhile, if the judgment is negative, the computer system proceeds to operation 207.

The determining can be carried out using a difference between values of the two highest degrees of influence or a ratio of values of the two highest degrees of influence. The determining is made, for example, but not limited to, by determining whether or not a difference between values for the two highest degrees of influence is equal or smaller than a predetermined value, or a ratio of values for the two highest degrees of influence is equal or greater than a predetermined value.

In a case where a difference between values for the two highest degrees of influence is used for the judgment, a smaller difference can be useful. A difference can be calculated by setting the highest degree of influence to a value, for example, one, calculating a value of the second highest degree of influence, corresponding to the value of the highest degree of influence, and then calculating a difference using the following equation:

Difference=(the value of the highest degree of influence) minus (a value of the second highest degree of influence).

If a difference is calculated using the aforesaid equation, it can be useful that a difference is equal or smaller than a predetermined value. A predetermined value used for a C&RT algorithm can be, for example, but not limited to, 0.005, which can be modified by, for example, a manger or user of a prediction model.

A predetermined value used for a CHAID algorithm where X² multiplier is used can be, for example, but not limited to, 56.912, which can be modified by, for example, a manger or user of a prediction model.

In a case where a ratio of values for the two highest degrees of influence is used for the judgment, a ratio can be calculated using the following equation:

A ratio=the second highest degree of influence/the highest degree of influence

If a ratio is calculated using the aforesaid equation, it can be useful that a ratio is equal or greater than a predetermined value. The predetermined value used can be, for example, but not limited to, 0.9 or more, which can be modified by, for example, a manger or user of a prediction model.

At operation 205, if the judgment in operation 204 is positive, the computer system proceeds to operation 206. Meanwhile, if the judgment in operation 204 is negative, the computer system proceeds to operation 207.

At operation 206, the computer system carries out a stepwise method to select one explanatory variable among the plurality of explanatory variables. The stepwise method can be a stepwise logistic regression or a stepwise linear regression. The following reference describes the stepwise methods in detail: “IBM SPSS Modeler 18.1.1 Algorithms Guide,” IBM ®, 2017.

The stepwise logistic regression can be carried out, for example, when the objective variable is of a binary value. The stepwise linear regression can be carried out, for example, when the objective variable is of a continuous value.

In the stepwise logistic regression, a probability of generation of a category from a plurality of explanatory variables is calculated for a categorical objective variable, by performing a logistic transformation on y obtained from a regression equation. Moreover, use of a stepwise method allows for selecting one from a plurality of explanatory variables which influences the objective variable, using score statistics; Likelihood Ratio (LR) statistic is recommended.

In the stepwise logistic regression, several methods are available for selecting explanatory variables. With the forced entry method, any explanatory variable in the explanatory variable list is entered into the prediction model. The forward stepwise, backward stepwise, and backward entry methods use either the Wald statistic or the Likelihood Ratio statistic for explanatory variable removal. The forward stepwise, forward entry, and backward stepwise use the score statistic or the Likelihood Ratio statistic to select explanatory variables for entry into the prediction model.

The forward stepwise, FSTEP, can be carried out as follows:
A-1. Estimate the parameter and likelihood function for the initial prediction model and let it be a current prediction model.
A-2. Based on the MLEs of the current prediction model, calculate the score statistic or Likelihood Ratio statistic for every explanatory variable eligible for inclusion and find its significance.
A-3. Choose the explanatory variable with the smallest significance (p-value). If that significance is less than the probability for an explanatory variable to enter, then go to operation A-4; otherwise, stop FSTEP.
A-4. Update the current prediction model by adding a new explanatory variable. If this results in a prediction model which has already been evaluated, stop FSTEP.
A-5. Calculate the significance for each explanatory variable in the current prediction model using LR or Wald's test.
A-6. Choose the explanatory variable with the largest significance. If its significance is less than the probability for explanatory variable removal, then go back to operation A-2. If the current prediction model with the explanatory variable deleted is the same as a previous prediction model, stop FSTEP; otherwise go to the next step.
A-7. Modify the current prediction model by removing the explanatory variable with the largest significance from the previous prediction model. Estimate the parameters for the modified prediction model and go back to operation A-5.

The backward stepwise, BSTEP, can be carried out as follows:
B-1. Estimate the parameters for the full prediction model which includes the final prediction model from previous method and all eligible variables. Only explanatory variables listed on the BSTEP variable list are eligible for entry and removal. Let the current prediction model be the full prediction model.
B-2. Based on the MLEs of the current prediction model, calculate the LR or Wald statistic or conditional statistic for every explanatory variable in the prediction model and find its significance.
B-3. Choose the explanatory variable with the largest significance. If that significance is less than the probability for an explanatory variable removal, then go to operation B-5; otherwise, if the current prediction model without the explanatory variable with the largest significance is the same as the previous prediction model, stop BSTEP; otherwise, go to the next step.
B-4. Modify the current prediction model by removing the explanatory variable with the largest significance from the prediction model. Estimate the parameters for the modified prediction model and go back to operation B-2.
B-5. Check to see any eligible explanatory variable is not in the prediction model. If there is none, stop BSTEP; otherwise, go to the next step.
B-6. Based on the MLEs of the current prediction model, calculate the score statistic for every explanatory variable not in the prediction model and find its significance.

B-7. Choose the explanatory variable with the smallest significance. If that significance is less than the probability for explanatory variable entry, then go to the next step; otherwise, stop BSTEP.
B-8. Add the explanatory variable with the smallest significance to the current prediction model. If the prediction model is not the same as any previous prediction models, estimate the parameters for the new prediction model and go back to operation B-2; otherwise, stop BSTEP.

The score statistic can be calculated for each explanatory variable not in the prediction model to determine whether the explanatory variable should enter the prediction model. The score statistic can be calculated by, for example, but not limited to, Likelihood Ratio (LR) statistic.

The LR statistic is defined as two times the log of the ratio of the likelihood functions of two prediction models evaluated at their maximum likelihood estimates (MLEs). The LR statistic is used to determine if an explanatory variable should be removed from the prediction model. Assume that there are ri explanatory variables in the current prediction model which is referred to as a full prediction model. Based on the MLEs of the full prediction model, l(full) is calculated. For each of the explanatory variables removed from the full prediction model one at a time, MLEs are computed and the likelihood function l(reduced) is calculated. The LR statistic is then defined as follows:

$$L R = - 2 ln ( \frac{l ( reduced )}{l ( full )} ) = - 2 ln ( L ( reduced ) - L ( full ) )$$

LR exhibits chi-square distribution having a degree of freedom equal to a difference in the number of parameters estimated in two models.

In the stepwise linear regression, this procedure performs ordinary least squares multiple linear regression with four methods for entry and removal of variables.

At operation 207, the computer system selects one explanatory variable among the plurality of explanatory variables, using a tree decision algorithm which can be known in the art. Any tree decision algorithm can be used in this step.

At operation 208, the computer system creates a prediction model using the selected explanatory variable, for example, by growing a node in the prediction model. The computer system can add a node into the prediction model or grow a lower layer node of the prediction model.

At operation 209, the computer system determines whether steps 202 to 208 are to be repeated or not. If there is any node to be processed in the decision tree, the computer system proceeds back to operation 202 in order to repeat steps 202 to 207 and then update the prediction model at operation 208 by adding a node into the prediction model or growing a lower layer node of the prediction model. Meanwhile, if there is no node to be processed in the decision tree, the computer system proceeds to a final operation 210.

At operation 210, the computer system terminates the aforesaid process. The created or updated prediction model can be used for executing the prediction model.

According to embodiments of the present disclosure mentioned in FIG. 2A, a combination of a decision tree and a stepwise method is used, for example, when a prediction model whose interpretation is difficult is created. This enables us to create a prediction model which can be easily interpreted in a manner fitted to business and which has high accuracy while capturing the overall relationship (rather than a partial relation) of an explanatory variable to an objective variable.

According to embodiments of the present disclosure mentioned in FIG. 2A, an explanatory variable is selected according to a stepwise method which captures overall relationship between an objective variable and an explanatory variable, rather than according to a decision tree algorithm which merely captures individual relationship between an objective variable and an explanatory variable. A stepwise method allows selection of an explanatory variable which influences an objective variable, while excluding common characteristics of the explanatory variables. Further, it is likely that a decision tree algorithm with a higher accuracy can be created by combining a decision tree having branches based on local information and a stepwise method which takes overall information into account. It is to be noted that the stepwise method is to be executed only when influences of the explanatory variables on an objective variable are equivalent or almost equivalent.

FIG. 2B illustrates a flow diagram depicting a process for using the prediction model made in accordance with embodiments of the present disclosure. A computer system mentioned below can be the same or different from the computer system 101 described in FIG. 1 and can be the same or different from the computer system mentioned in the aforesaid steps 201 to 210.

At operation 211, the computer system starts the aforesaid process.

At operation 212, the computer system executes the prediction model which was created in the operation 208 described in FIG. 2A in order to analyze data.

At operation 213, the computer system terminates the aforesaid process.

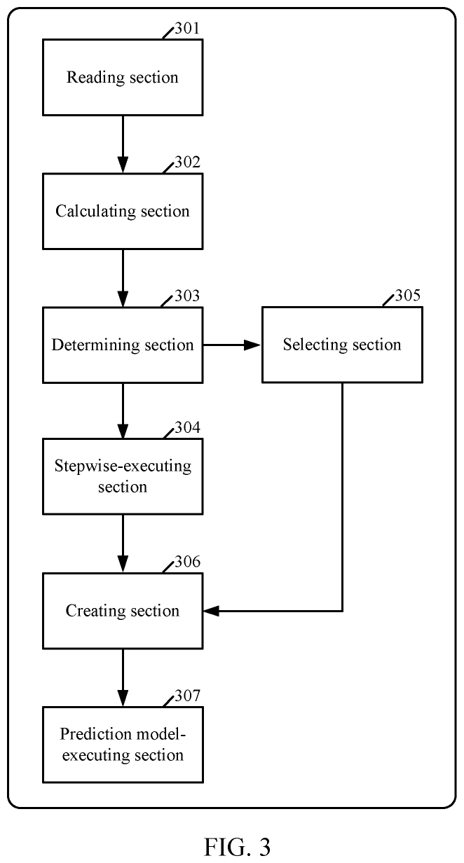

FIG. 3 illustrates an overall functional block diagram of depicting a computer system hardware in relationship to the process of FIG. 2A, in accordance with embodiments of the present disclosure.

The computer system 301 can correspond to the computer system 101 described in FIG. 1. The computer system 301 can include a reading section 301, a calculating section 302, a determining section 303, a stepwise-executing section 304, a selecting section 305, a creating section 306. The computer system 301 can further include a prediction model-executing section 307.

The reading section 301 reads an objective variable and a plurality of explanatory variables into a memory.

The reading section 301 can perform operation 202 described in FIG. 2A.

The calculating section 302 calculates a degree of influence of each of the plurality of explanatory variables on the objective variable.

The calculating section 302 can perform operation 203 described in FIG. 2A.

The determining section 303 determines whether the two highest degrees of influence are approximate with each other or not.

The determining section 303 can perform steps 204 and 205 described in FIG. 2A.

The stepwise-executing section 304 carries out a stepwise method to select one explanatory variable among the plurality of explanatory variables, if the two highest degrees of influence are approximate with each other.

The stepwise-executing section 304 can perform operation 206 described in FIG. 2A.

The selecting section 305 selects one explanatory variable among the plurality of explanatory variables, using a tree decision algorithm which can be known in the art, if the two highest degrees of influence are not approximate with each other.

The selecting section 305 can perform operation 207 described in FIG. 2A.

The creating section 306 creates a prediction model using the selected explanatory variable. The creating section 306 also updates the prediction model using the selected explanatory variable when the following steps are repeated: the steps of calculating a degree of influence of each of the plurality of explanatory variables on the objective variable, determining whether the two highest degrees of influence are approximate with each other or not, and if the two highest degrees of influence are approximate with each other, carrying out a stepwise method to select one explanatory variable among the plurality of explanatory variables.

The creating section 306 can perform operation 208 described in FIG. 2A.

The prediction model-executing section 307 executes the prediction model which was created in the operation 208 described in FIG. 2A in order to analyze data.

The prediction model-executing section 307 can perform the steps 211 to 213 described in FIG. 2B.

A prediction model for predicting hospitalization risk, hereinafter referred to as “the prediction model-A,” was created using the existing decision tree algorithm. Further, a prediction model for predicting hospitalization risk, hereinafter referred to as “the prediction model-B,” was created according to embodiments of the present disclosure, wherein a stepwise logistic regression is used as a stepwise method.

A set of data was provided for predicting hospitalization risk.

1. Analysis of the set of data, using the prediction model-A

The following results were obtained: there is almost no difference between (1) medication and (2) dietetic therapy/kinesitherapy; however, the former (1) has a slightly higher influence.

2. Analysis of the set of data, using the prediction model-B.

The following results were obtained: comparing (1) medication (an odds ratio: 0.85) with (2) dietetic therapy/kinesitherapy (an odds ratio: 0.26), the latter (2) has a higher influence. Note that “an odds ratio” means a value for comparing two groups as to their “influence factor”. This value is utilized only in capturing the contribution order of a plurality of influence factors. A value greater than one represents a positive influence, and a value less than one represents a negative influence.

3. Evaluation:

A comparison of the results obtained in Item 1. with the results obtained in Item 2. showed that the branching with Item 2 exhibited a higher accuracy.

According to the results obtained in Item 2, (2) dietetic therapy/kinesitherapy was identified as a factor of hospitalization risk, which accelerated providing a new discernment, i.e., interpretation of the model).

According to the results obtained in Item 2, it is possible to objectively explain reasons for selecting an explanatory variable for an objective variable. Thus, it is expected to contribute to improvement of customer satisfaction in business, such as cost reduction and maximization of customer's benefit.

Further, according to the results obtained in Item 2, these results showed a higher accuracy, compared to those obtained in Item 1.

Further, according to the results obtained, systematization can be achieved by determining whether a stepwise method in a series of the steps described in FIG. 2A is carried out.

The present disclosure can be a method, a system, and/or a computer program product. The computer program product can include a computer-readable storage medium (or media) having computer-readable program instructions thereon for causing a processor to carry out embodiments of the present disclosure.

The computer-readable storage medium can be a tangible device that can retain and store instructions for use by an instruction execution device. The computer-readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer-readable program instructions by utilizing state information of the computer-readable program instructions to personalize the electronic circuitry, in order to perform aspects of the present disclosure.

Embodiments of the present disclosure are described herein with reference to flow diagram illustrations and/or block diagrams of methods, apparatus (systems), and computer program products according to embodiments of the disclosure. It will be understood that each block of the flow diagram illustrations and/or block diagrams, and combinations of blocks in the flow diagram illustrations and/or block diagrams, can be implemented by computer-readable program instructions.

These computer-readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow diagram and/or block diagram block or blocks. These computer-readable program instructions can also be stored in a computer-readable storage medium that can direct a computer, a programmable data processing apparatus, and/or other devices to function in a particular manner, such that the computer-readable storage medium having instructions stored therein includes an article of manufacture including instructions which implement aspects of the function/act specified in the flow diagram and/or block diagram block or blocks.

The computer-readable program instructions can also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flow diagram and/or block diagram block or blocks.

The flow diagram and block diagrams in the Figures illustrate the architecture, functionality, and operation of possible implementations of systems, methods, and computer program products according to various embodiments of the present disclosure. In this regard, each block in the flow diagram or block diagrams can represent a module, segment, or portion of instructions, which includes one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flow diagram illustration, and combinations of blocks in the block diagrams and/or flow diagram illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method for creating a prediction model, the method comprising:
reading an objective variable and a plurality of explanatory variables into a memory;
calculating a degree of influence of each of the plurality of explanatory variables upon the objective variable;
determining that two highest degrees of influence are approximate with each other;
carrying out, in response to the two highest degrees of influence being approximate with each other, a stepwise method to select one explanatory variable of the plurality of explanatory variables; and
creating, using the selected explanatory variable, a prediction model.

2. The method of claim 1, the stepwise method is selected from the group consisting of: a stepwise logistic regression and a stepwise linear regression.

3. The method of claim 1, the method further comprising:
calculating a degree of influence of each explanatory variable of the plurality of explanatory variables upon the objective variable;
determining that the two highest degrees of influence are approximate with each other;
carrying out, in response to the two highest degrees of influence being approximate with each other, a stepwise method to select one explanatory variable among the plurality of explanatory variables; and
updating the prediction model using the selected explanatory variable.

4. The method of claim 1, wherein the prediction model has a decision tree structure.

5. The method of claim 1, wherein the determining is carried out using a difference between values of the two highest degrees of influence or a ratio of values of the two highest degrees of influence.
